(19) United States
(12) Patent Application Publication
(10) Pub. No.: US 2010/0165632 A1
(43) Pub. Date: Jul. 1, 2010

(54) HEAT DISSIPATION DEVICE AND LUMINAIRE COMPRISING THE SAME

(75) Inventor: Chia Hao LIANG, Tucheng City (TW)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: EVERLIGHT ELECTRONICS CO., LTD., Tucheng City (TW)

(21) Appl. No.: 12/646,525

(22) Filed: Dec. 23, 2009

(30) Foreign Application Priority Data
Dec. 26, 2008 (TW) 097150868

(51) Int. Cl. F21V 29/00; F21V 21/00

(52) U.S. Cl. 362/294; 362/382; 362/373

(57) ABSTRACT

A heat dissipation device and a luminaire comprising the same are provided. The luminaire comprises a first circuit board, a light-emitting diode, the heat dissipation device, a circuit device, a bulb cap. The first circuit board has a first surface and a second surface opposite to the first surface. The light-emitting diode is disposed on the first surface and electrically connected to the first circuit board. The heat dissipation device comprises a fan module and a plurality of heat dissipation channels. The fan module is disposed on the second surface of the first circuit board and electrically connected to the first circuit board. The heat dissipation channels are connected to an atmosphere, wherein the fan module is adapted to generate airflow to pass the heat dissipation channels to the ambient. The circuit device is electrically connected to the first circuit board, and the bulb cap is electrically connected to the circuit device to provide power to the first circuit board and the light-emitting diode.

This application claims priority to Taiwan Patent Application No. 097150868 filed on Dec. 26, 2008; the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a heat dissipation device, and more particularly, to a heat dissipation device for use in a luminaire.

2. Descriptions of the Related Art

Power-saving light bulbs and fluorescent tubes have found wide applications and are mainly used to provide illumination. Conventional fluorescent bulbs emit light under the following principle: mercury (Hg) within the bulbs emits ultraviolet light via the action of electrons, and the fluorescent powder coated on the bulbs absorbs and converts the ultraviolet light with an original wavelength of 253 nm into visible light with a wavelength of 400-700 nm. However, the mercury in the bulbs does not comply with relevant environmental protection standards, and there still needs to be improvement in light emitting efficiencies. On the other hand, light emitting diode (LED) bulbs are known to have a longer service life than tungsten-filament bulbs and fluorescent bulbs, and can deliver a light emitting efficiency that is several times higher than that of the traditional tungsten-filament bulbs. Therefore, LED bulbs that are mercury free and have a higher light emitting efficiency will gradually replace traditional tungsten-filament bulbs and become the mainstream lighting product in the future.

However, high-brightness LED bulbs that are currently available tend to generate massive heat due to the high power consumption. The high temperature caused by the intense heat shortens the service life of the LED, and the light emitting efficiency also degrades due to the high temperature. Because LED bulbs emit massive heat within small internal spaces, heat dissipation devices must be used to rapidly dissipate heat. Unfortunately, common LED bulbs commercially available usually exhibit poor heat dissipation performance. Consequently, these products tend to overheat, leading to an instable light emitting performance or even damage to the products.

In view of this, it is necessary to provide a heat dissipation device with high heat dissipation efficiency and a luminaire comprising the same to enhance the light emitting efficiency, improve the overall reliability and prolong the service life of the products.

### SUMMARY OF THE INVENTION

The objective of this invention is to provide a heat dissipation device for use in a luminaire, and a luminaire comprising the same. The heat dissipation device is adapted to dissipate heat generated by the luminaire to the atmosphere to decrease the overall temperature of the luminaire.

To this end, the luminaire of this invention comprises a first circuit board, a light-emitting diode (LED), a heat dissipation device, a circuit device and a bulb cap. The first circuit board has a first surface and a second surface opposite to the first surface. The light-emitting diode is disposed on the first surface and electrically connected to the first circuit board. The heat dissipation device comprises a fan module and a plurality of heat dissipation channels. The fan module is disposed on the second surface of the first circuit board and electrically connected to the first circuit board. The plurality of heat dissipation channels is connected to the atmosphere, wherein the fan module generates the airflow passing the heat dissipation channels to atmosphere. The circuit device is electrically connected to the first circuit board. The bulb cap is electrically connected to the circuit device to provide a power to the first circuit board and the light-emitting diode.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a perspective view of the luminaire of this invention;

FIG. 2 is an exploded view of the luminaire of this invention; and

FIG. 3 is a schematic view of a heat dissipation device of this invention.

### DESCRIPTION OF THE PREFERRED EMBODIMENT

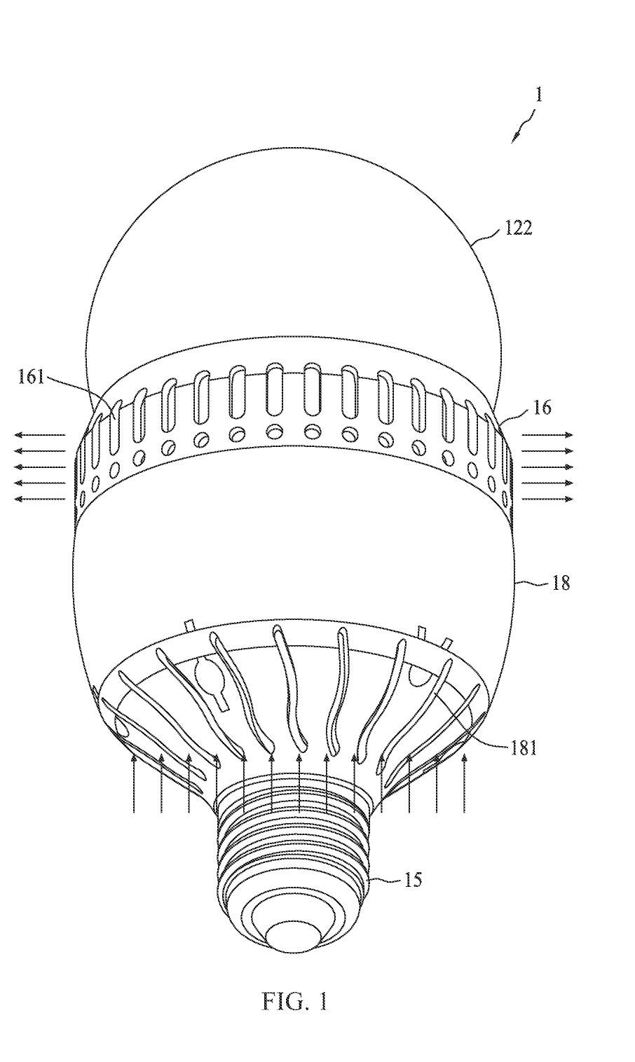

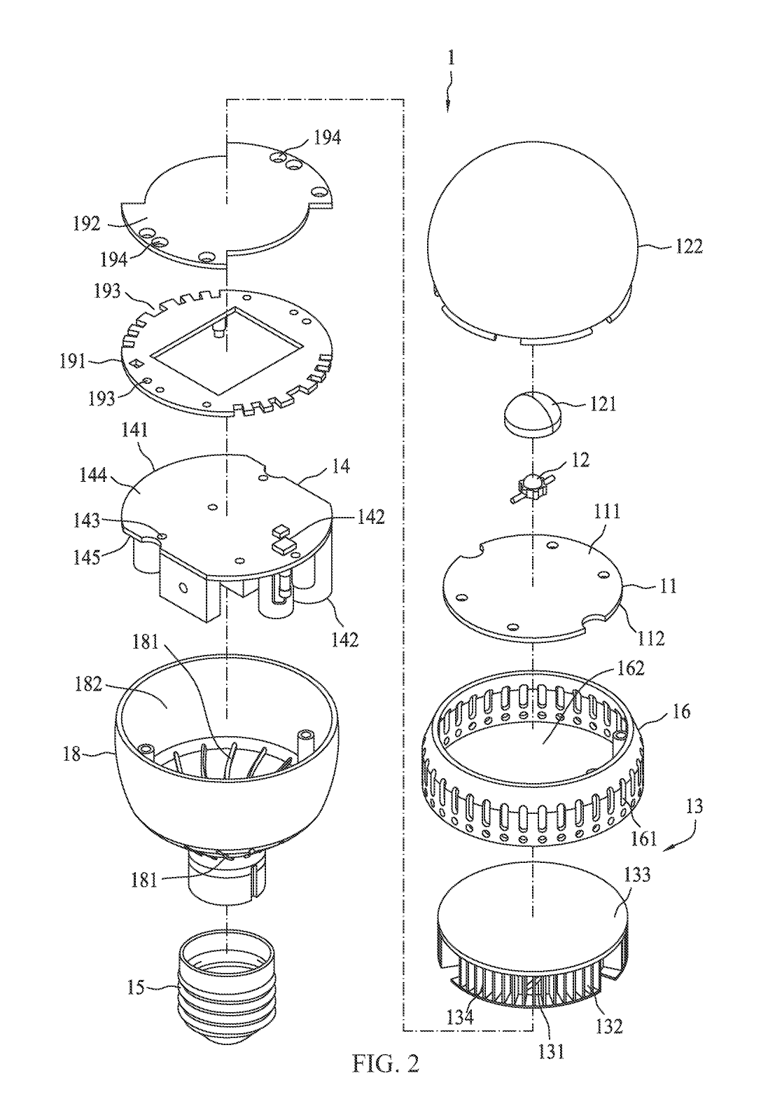

FIG. 1 is the perspective view of a luminaire 1 of this invention. The luminaire 1 of this embodiment is shaped like a common bulb. In reference to FIG. 2, an exploded view of the luminaire shown in FIG. 1 is illustrated therein. The luminaire 1 of this invention comprises a first circuit board 11, an LED 12, a heat dissipation device 13, a circuit device 14 and a bulb cap 15. The first circuit board 11 has a first surface 111 and a second surface 112 opposite to the first surface 111. The LED 12 is disposed on the first surface 111 and electrically connected to the first circuit board 11. Because the luminaire 1 of this invention uses the LED 12 as a light source, it does not comprise hazardous substances that are possibly comprised in various fluorescent bulbs, such as mercury, lead, cadmium, and hexavalent chromium, and complies with the Restriction of the use of certain hazardous substances in electrical and electronic equipment (RoHS) promulgated by Europe Union (EU). By means of the heat dissipation device 13, the luminaire 1 of this invention may further dissipate the heat generated by the LED 12 outwards to decrease the overall temperature of the luminaire 1, thereby prolonging the service life and improve the light emitting efficiency thereof.

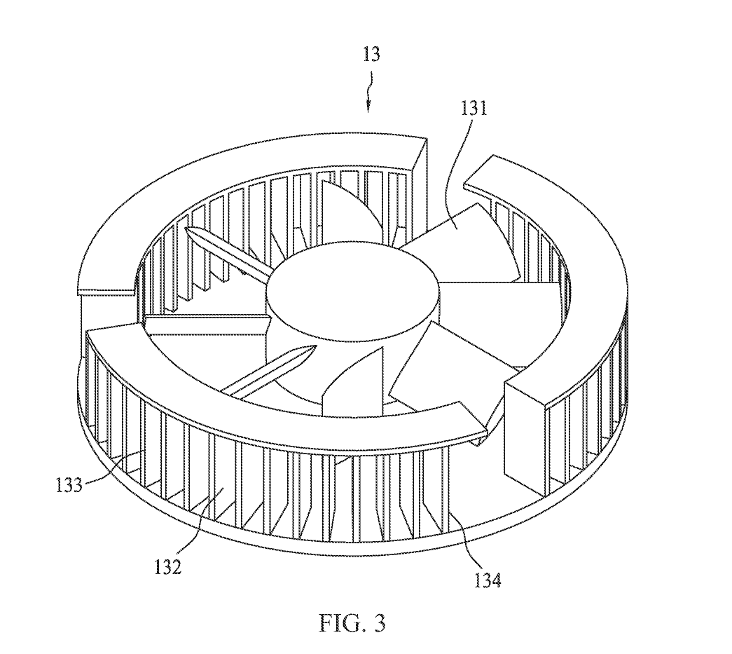

In reference to both FIGS. 2 and 3, the heat dissipation device 13 of this invention comprises a fan module 131, a plurality of heat dissipation channels 132 and a heat sink 133. The fan module 133 is disposed on the second surface 112 of the first circuit board 11 and has a plurality of fins 134. The fins 134 are annularly disposed around the periphery of the fan module 131, and define the heat dissipation channels 132 leading to the atmosphere. The fan module 131 is disposed on the second surface 112 of the first circuit board 11 and electrically connected to the first circuit board 11. The fan module 131 is adapted to generate the airflow passing the heat dissipation channels 132 to the atmosphere, thereby improving the heat dissipation efficiency remarkably.

The LED 12 is disposed on the first surface 111 of the first circuit board 11. To guide the massive heat generated by the LED 12 to the heat dissipation module 13 rapidly, the first circuit board 11 comprises a diamond-like carbon (DLC) membrane to disperse the heat generated by the LED 12. The DLC membrane has a heat conductivity of substantially 400 W/mK, which is close to that of copper. Because the DLC membrane has a high heat conductivity, the heat from the LED 12 can be conducted to the first circuit board 11 rapidly. The DLC membrane may be obtained through a physical vapor deposition (PVD) or a chemical vapor deposition (CVD), both of which are conventional technologies for membrane formation and thus will not be further described herein. The first circuit board 11 should be a Metal Core Printed Circuit Board (MCPCB) to assist in dissipating the heat generated by the LED 12. In particular, the MCPCB is formed by attaching an original PCB onto another metallic substrate with better heat conduction performance (e.g., aluminum, copper or the like) to replace the plastic substrates of common PCBs for an enhanced heat dissipation effect. In this embodiment, the first PCB 11 uses an aluminum substrate that has a heat conductivity of substantially 200 W/mK. Accordingly, the first circuit board 11 as a whole has a heat conductivity of substantially larger than 200 W/mK.

Furthermore, in reference to FIG. 2, the heat dissipation device 13 of the luminaire 1 further comprises a housing 16, which comprises a plurality of convection holes 161 and a receiving space 162. The fan module 131 and the heat sink 133 of the heat dissipation module 13 are disposed inside the receiving space 162 of the housing 16. The convection holes 161 of the housing 16 and the heat sink 133 corporately define the heat dissipation channels 132 so that the airflow generated by the fan module 131 communicates with the atmosphere via the convection holes 161. This can prevent the housing 16 that have no convection holes 161 formed thereon from interfering with the airflow and consequently avoid the degradation of the heat dissipation efficiency. It should be noted herein that, in other embodiments, the housing 16 may further be formed integrally with the heat sink 133.

In this embodiment, the luminaire 1 further comprises an auxiliary housing 18 that is joined with the housing 16 to form a complete housing. However, it should be noted herein that, instead of forming the auxiliary housing 18 and the housing 16 as two separate elements as in this embodiment, the auxiliary housing 18 may also be formed integrally with the housing 16 in other examples. The auxiliary housing 18 also comprises a plurality of convection holes 181 and a receiving space 182, and the circuit device 14 is fixedly received in the receiving space 182 of the auxiliary housing 18. The convection holes 181 of the auxiliary housing 18 and the convection holes 161 of the housing 16 cooperate with each other for the airflow generated by the fan module 131 flowing into and out of the interior of the luminaire 1, thereby improving the heat dissipation efficiency. The housing 16 and the auxiliary housing 18 should be made of plastic materials, for example, polycarbonate (PC).

In this embodiment, the bulb cap 15 of the luminaire 1 is disposed on the auxiliary housing 18 to join with the bulb socket. It should be noted herein that, in other examples, rather than being limited thereto, the bulb cap 15 may also be joined to other locations of the housing 16 or the auxiliary housing 18. The bulb cap 15 should be an E27 standard bulb cap, which has standard dimensions and standard connecting threads and can be mounted onto a standard bulb socket easily in a plug-and-play manner. In other embodiments, other standard bulb caps may also be used for electrical connection.

The circuit device 14 of the luminaire 1 is electrically connected to the first circuit board 11, and the bulb cap 15 is electrically connected to the circuit device 14 to supply power to the first circuit board 11 and the LED 12. The circuit board 14 further comprises a second circuit board 141, a plurality of circuit components 142 and a plurality of through holes 143. These through holes 143 allow the airflow to pass therethrough for heat dissipation. The second circuit board 141 has a first surface 144 and a second surface 145 opposite to the first surface 144. The circuit components 142 disposed on the second circuit board 141 are configured to modify and supply power to the first circuit board 11. The circuit components 142 may be classified into active components and passive components. The passive components that have a bulky volume, such as capacitors, are disposed on the second surface 145 out of mechanical design considerations, while circuit components 142 that have a smaller volume are disposed on the first surface 144. Such a mechanical design allows for better utilization of the space and reduction in thermal shock.

To assist in the fixation of various parts within the luminaire 1, the luminaire 1 further comprises a fixing assembly which comprises a plastic plate 191 and an aluminum plate 192. To prevent interference with the airflow, the plastic plate 191 and the aluminum plate 192 also have a plurality of through holes 193 and 194 respectively. The through holes 193 and 194 allow the airflow to pass therethrough for heat dissipation.

To uniformize the light emitted by the LED 12, the luminaire 1 further comprises a domed scattering lens 121. The LED 12 is disposed between the first circuit board 11 and the scattering lens 121 to assist in scattering the light emitted by the LED 12, thereby making the light from the luminaire 1 uniform. The luminaire 1 further comprises a transparent lamp cover 122. The transparent lamp cover 122 is adapted to be joined with the housing 16 and at least cover the first surface 111 of the first circuit board 11 and the LED 12.

In reference to both FIGS. 1 and 2, the heat dissipation airflow path of the luminaire 1 is described as follows. As shown by the arrows in FIG. 1, carried by the airflow of the fan module 131, the heat generated by the LED 12 passes through the heat dissipation channels 132 and the convection holes 161 of the housing 16 to the atmosphere, and the plurality of convection holes 181 of the auxiliary housing 18 is adapted to replenish the air. After entering the luminaire 1 from the convection holes 181 of the auxiliary housing 18, the airflow passes through the plurality of through holes 143 of the second circuit board 141 of the circuit device 14 and the plurality of though holes 193, 194 formed in the plastic plate 191 and the aluminum plate 192 of the fixing assembly and then arrives at the heat dissipation device 13 where the intense heat generated by the LED 12 is dissipated. Because the DLC and the first circuit board 11 of the metallic substrate have high heat conduction efficiencies, the intense heat generated by the LED 12 is transferred rapidly to the heat sink 133 of the heat dissipation device 13 and further to the heat dissipation channels 132 from the fins 134 of the heat sink 133. At this point, the airflow generated by the fan module 131 of the heat dissipation device 13 carries the heat generated by the LED 12 away rapidly via the heat dissipation channels 132 and then flows out of the convection holes 161 of the housing 16. In this way, the interior of the luminaire 1 and the LED 12 can be maintained at an appropriate temperature, thereby avoiding degradation in the light emitting efficiency and shortening of the service life of the LED 12. Furthermore, the circuit components on the circuit device 14 are disposed in such a way that the active circuit components face upwards while the passive ones face downwards, so the airflow can carry away more heat generated by the passive ones. It should be noted herein that, those of ordinary skill in the art may readily appreciate that the fan module 131 may also rotate in the reverse direction to generate airflow flowing in the reverse direction, which may also accomplish heat dissipation.

Consequently, when the luminaire 1 of this invention operates at an ambient temperature of 25° C. and a high-power LED 12 with a power consumption of 20 W is used, the junction temperature (Tj) of the LED 12 is lower than 70° C. In contrast, for conventional LED bulbs without the fan module 131 and the DLC membrane, the junction temperature of the LEDs goes higher than 125° C.

According to the above descriptions, this invention utilizes the DLC material on the first circuit board and the fan module in combination to dissipate the heat generated by the LED, thereby decreasing the temperature thereof. Meanwhile, cool air may be replenished through the convection holes of the auxiliary housing so that forced air convection can be accomplished through the plurality of through holes in the second circuit board, the plastic plate and the aluminum plate, the plurality of heat dissipation channels, and the plurality of convection holes in the housing to cool the LED and dissipate heat. Compared to the prior art, the special heat dissipation device included in this invention allows for rapid heat conduction and dissipation, so the light emitting efficiency and service life of the LED are improved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A heat dissipation device for a luminaire, the luminaire comprising a first circuit board and a light-emitting diode, in which the first circuit board has a first surface and a second surface opposite to the first surface, the light-emitting diode is disposed on the first surface and electrically connected to the first circuit board, and the heat dissipation device comprises:
a fan module disposed on the second surface of the first circuit board; and
a plurality of heat dissipation channels connected to atmosphere, wherein the fan module generates airflow passing the heat dissipation channels to atmosphere.

2. The heat dissipation device as claimed in claim 1, further comprising a heat sink disposed on the second surface of the first circuit board.

3. The heat dissipation device as claimed in claim 2, wherein the heat sink has a plurality of fins annularly disposed along a periphery of the fan module.

4. The heat dissipation device as claimed in claim 2, further comprising a housing, wherein the housing comprises a plurality of convection holes and a receiving space for the fan module and the heat sink, the convention holes and the heat sink corporately define the heat dissipation channels and the fan module generates airflow passing the convention holes to atmosphere.

5. The heat dissipation device as claimed in claim 4, wherein the housing and the heat sink are made integrally.

6. The heat dissipation device as claimed in claim 1, wherein the first circuit board comprises a diamond-like carbon (DLC) membrane to disperse the heat generated by the light-emitting diode.

7. The heat dissipation device as claimed in claim 1, wherein the first circuit board is a Metal Core Printed Circuit Board (MCPCB).

8. A luminaire, comprising:
a first circuit board having a first surface and a second surface opposite to the first surface;
a light-emitting diode disposed on the first surface and electrically connected to the first circuit board;
a heat dissipation device comprising:
a fan module, disposed on the second surface of the first circuit board and electrically connected to the first circuit board; and
a plurality of heat dissipation channels, connected to an atmosphere, wherein the fan module generates airflow passing the heat dissipation channels to atmosphere;
a circuit device electrically connected to the first circuit board; and
a bulb cap electrically connected to the circuit device to provide a power to the first circuit board and the light-emitting diode.

9. The luminaire as claimed in claim 8, wherein the heat dissipation device further comprises a heat sink, and the heat sink is disposed on the second surface of the first circuit board.

10. The luminaire as claimed in claim 9, wherein the heat sink has a plurality of fins annularly disposed along a periphery of the fan module.

11. The luminaire as claimed in claim 9, wherein the heat dissipation device further comprises a housing, the housing has a plurality of convection holes and a receiving space for the fan module and the heat sink, the convention holes and the heat sink corporately define the heat dissipation channels and the fan module generates airflow passing the convention holes to atmosphere.

12. The luminaire as claimed in claim 8, wherein the first circuit board comprises a diamond-like carbon membrane (DLC) to disperse the heat generated by the light-emitting diode.

13. The luminaire as claimed in claim 8, wherein the first circuit board is a Metal Core Printed Circuit Board (MCPCB).

14. The luminaire as claimed in claim 9, wherein the circuit device further comprises a second circuit board, the second circuit board has a plurality of circuit components and a plurality of through holes, the circuit components modify and provide the power to the first circuit board, and the through holes are passed by the airflow.

15. The luminaire as claimed in claim 14, wherein the luminaire further comprises an auxiliary housing joined with the housing, the auxiliary housing comprises a plurality of convection holes and a receiving space, and the circuit device is fastened and received in the receiving space.

16. The luminaire as claimed in claim 15, wherein the bulb cap is disposed on the auxiliary housing.

17. The luminaire as claimed in claim 15, wherein the housing and the heat sink are made integrally.

18. The luminaire as claimed in claim 8, further comprising a diffusing lens, wherein the light-emitting diode is disposed between the first circuit board and the diffusing lens.

19. The luminaire as claimed in claim 8, further comprising a transparent lamp cover, wherein the transparent lamp cover at least covers the light-emitting diode and the first surface of the first circuit board.

20. The luminaire as claimed in claim 8, wherein the bulb cap is an E27 standard bulb cap.
